(19) United States
(12) Patent Application Publication
(10) Pub. No.: US 2007/0158516 A1
(43) Pub. Date: Jul. 12, 2007

(54) Liquid crystal display

(76) Inventor: Ching-Hsien Huang, Taipei (TW)

Correspondence Address: LEONG C LEI, PMB # 1008, 1867 YGNACIO VALLEY ROAD, WALNUT CREEK, CA, 94598, US

(21) Appl. No.: 10/422,769

(22) Filed: Apr. 25, 2003

(30) Foreign Application Priority Data
Feb. 21, 2003 (TW) 092202771

(51) Int. Cl. E04G 3/00; F16M 11/00

(52) U.S. Cl. 248/284.1; 248/923; 248/682

(57) ABSTRACT

A liquid crystal display (LCD) is disclosed. The LCD includes: a screen; a pivot seat mounted at the rear surface of the screen; a connection rod; a first hinge chain positioned at the pivot seat and the top end of the connection rod so as to adjust the observation angle of the screen; a seat body; a pivotal section mounted onto the seat body; and a second hinge chain positioned at the pivot seat and the other top end of the connection rod so as to adjust the height of the screen.

### BACKGROUND OF THE INVENTION

(a) Technical Field of the Invention

The present invention relates to liquid crystal display (LCD) structure. More particular, an improved structure of a LCD, wherein the height of the display is adjustable, the structure of the display is simple, and the method of installation and operation are convenient.

(b) Description of the Prior Art

LCD without adjustable height structure may not be suitable to user of too short or too tall in height. One way of overcoming this problem of fixed height LCD is by adjusting the height of the table or desk supporting the display. It is very common that the desk or the table is placed with too many articles or objects, such as the host computer, printer, etc. As a result, the adjustment of the height of the table is laborious. Even the height of the table is adjusted, the relative position of the user may cause an uncomfortable sitting position for a prolonged period of operating the computer. Accordingly, it is an object of the present invention to overcome the above drawback by providing an improved structure of a LCD.

Taiwanese patent publication nos. 375316, 390451 disclose structure of conventional LCD. The LCD is provided with a retractable platform device or a hydraulic cylinder is used to adjust the height of the LCD. However, one common drawback of these two LCDs is that the structure thereof is complicated and therefore, it is very laborious in the course of installation. This will cause an increase in cost of production. Besides, the operation to adjust the height of the LCD is not convenient. The weight of the LCD has been increased which not only occupy space but also cause inconvenience in the cause of transporting.

Therefore, it is an object of the present invention to provide an improved structure of a LCD, which mitigates the drawbacks disclosed above.

### SUMMARY OF THE INVENTION

Accordingly, it is an object of the present invention to provide an improved structure of a LCD, wherein the structure allows the LCD to be adjusted in height, and the method of operation is simple.

Yet another object of the present invention is to provide an improved structure of a LCD, comprising a screen; a pivot seat mounted at the rear surface of the screen; a connection rod; a first hinge chain positioned at the pivot seat and the top end of the connection rod so as to adjust the observation angle of the screen; a seat body; a pivotal section mounted onto the seat body; and a second hinge chain positioned at the pivot seat and the other top end of the connection rod so as to adjust the height of the screen.

A further object of the present invention is to provide an improved structure of a LCD, comprising a screen; a pivot seat mounted at the rear surface of the screen; a connection rod; a first hinge chain positioned at the pivot seat and the top end of the connection rod so as to adjust the observation angle of the screen; a seat body having a plurality of hanging holes; a pivotal section mounted onto the seat body; and a second hinge chain positioned at the pivot seat and the other top end of the connection rod so as to adjust the height of the screen.

Still another object of the present invention is to provide an improved structure of a LCD, wherein the pivot seat is positioned at the rear surface of the screen and protruded beyond the rear surface of the screen forming into a cavity space.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of an improved structure of a LCD of the present invention.

FIG. 2 is a schematic view showing the action of the LCD of the present invention.

FIG. 3 is a schematic view of the LCD mounted on the wall in accordance with the present invention.

FIG. 4 is a schematic view showing the rear side of the LCD mounted on the wall in accordance with the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

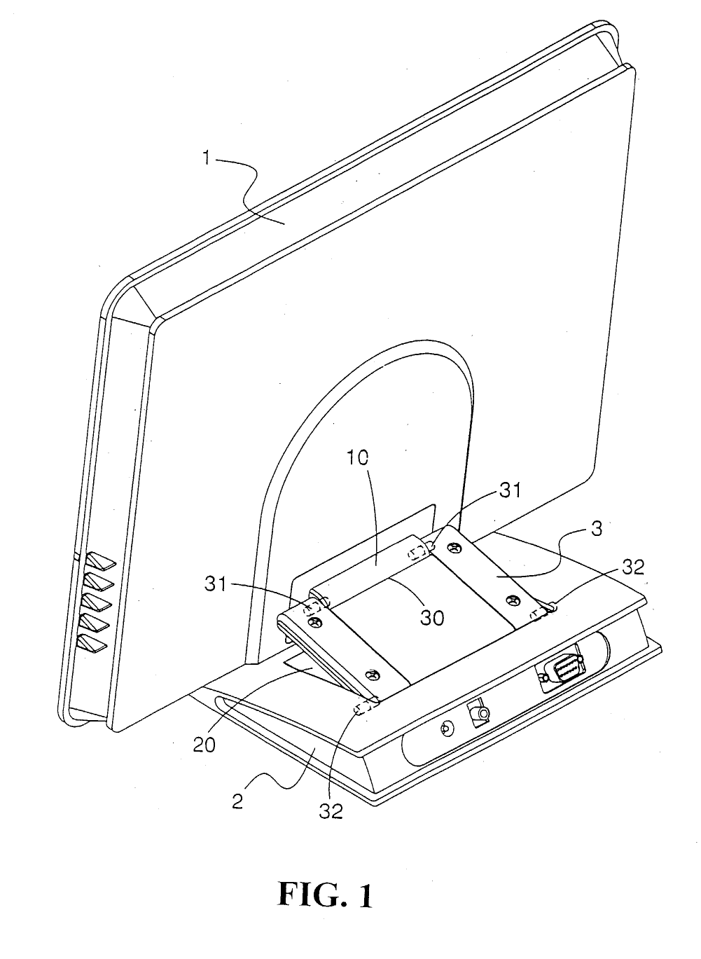

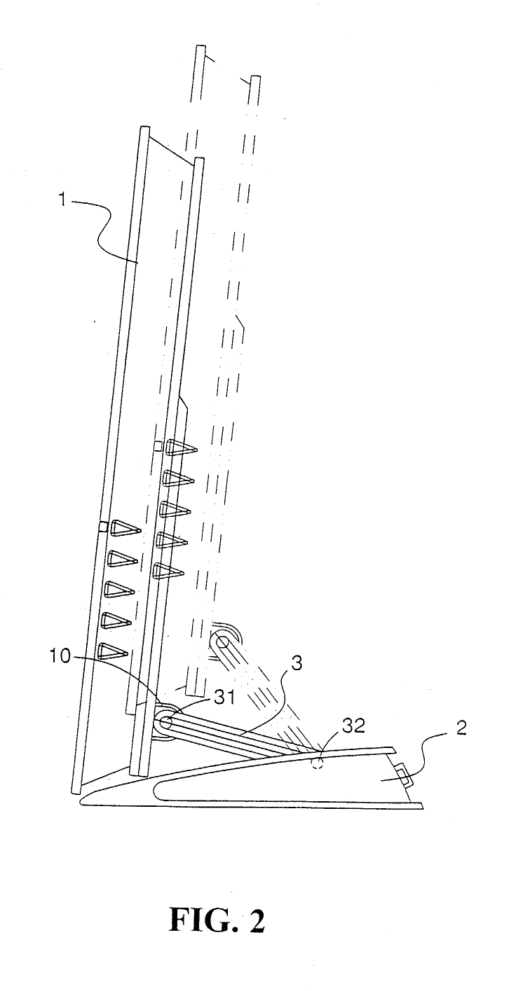

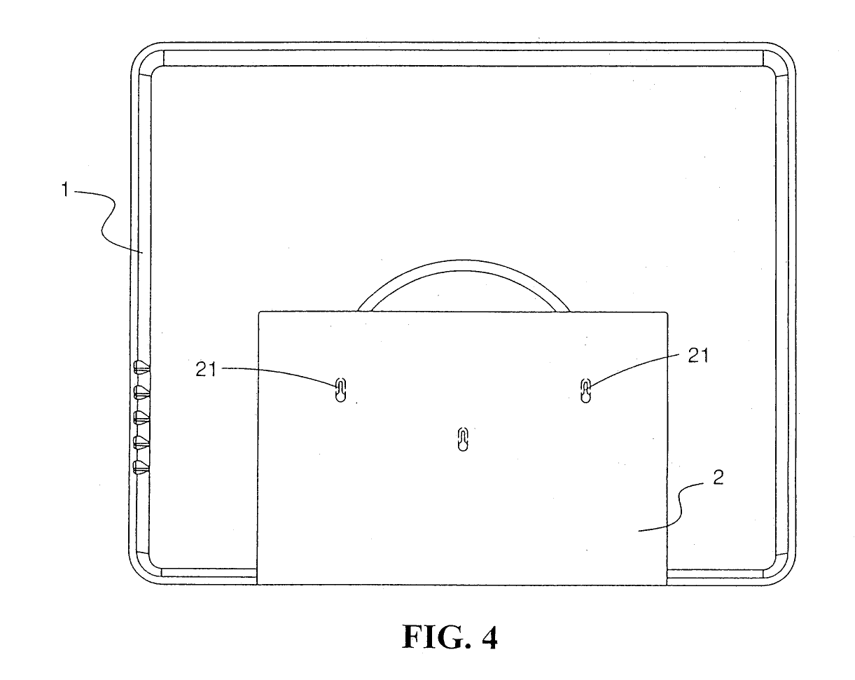

Referring to FIGS. 1 and 2, there is shown an improved structure of a LCD of the present invention comprising a screen 1 having a pivot seat 10 positioned at the rear side of the screen 1, a seat body 2 having a pivot section 20 located on the top face of the seat body 2, and the bottom face of the seat body 2 provided with a plurality of hanging holes 21, as shown in FIG. 4.

The structure further comprises a connection rod 3 having one side edge provided with an engaging slot 30. The two inner sidewalls of the engaging slot 30 are mounted at the two sides of the pivot seat 10. The two inner sidewalls of the engaging slot 30 are mounted with a hinge chain 31 which is pivotally mounted to the pivot seat 10 of the screen 1. The other side edge of the connection rod 3 is provided with a second hinge chain 32 for pivotally connection to the two lateral side walls of the pivotal section 20 of the seat body 2.

Referring to FIG. 2, the connection rod 3 can swing at an appropriate angle with respect to the second hinge chain 32 so that the screen 1 at the other side end can be adjusted when the second hinge chain 32 swings along the edge.

The screen 1 uses the pivotally mounted first hinge chain 31 so as to adjust the vision angle of the screen 1.

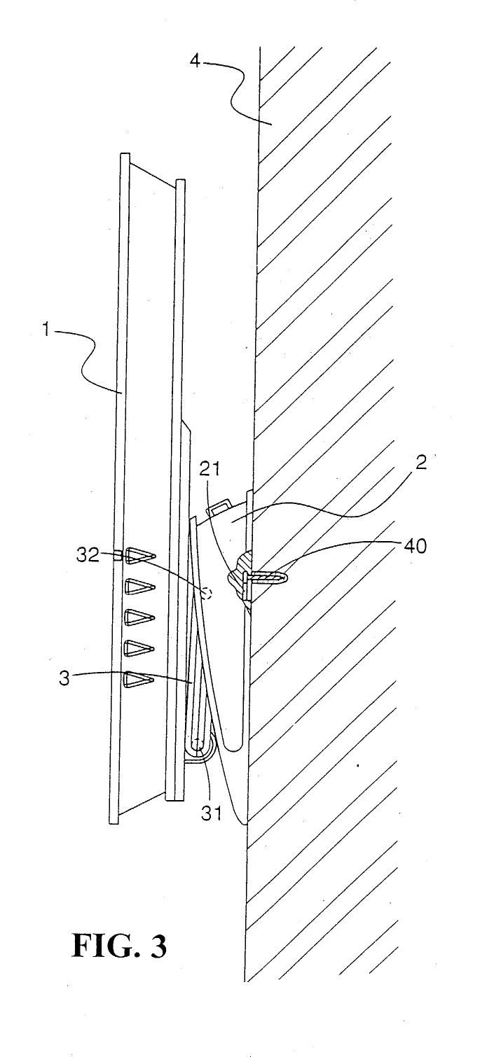

Referring to FIGS. 3 and 4, the bottom section of the seat body 2 is provided with a plurality of hanging holes 21. Thus, by employing the first hinge chain 31 and the second hinge chain 32, the seat body is mounted at the rear side of the screen 1, and is parallel with the screen 1. Thus, the hanging hole 21 is positioned onto a securing peg 40 on the wall 4. The LCD is thus positioned on the wall 4 for displaying purpose or use as a touch control display.

In accordance with the present invention, a connection rod 3 is connected between the screen 1 and the seat body 2 such that the screen 1 can be adjusted as a result of the swinging of the connection rod 3. In view of the above, the structure is simple and the method of installation is convenient, and thus the cost of production is greatly reduced.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1.-11. (canceled)

2. A liquid crystal display structure comprising:
a screen;
a pivot seat mounted at the rear surface of the screen, the pivot seat is positioned at a rear surface of the screen and protruded beyond the rear surface of the screen forming into a cavity space;
a seat body having a plurality of hanging holes, the seat body including a top and bottom plate, and the bottom plate being parallel to placing surface, the top plate and the bottom plate being connected at an acute angle and being extended to form a parallel structure, a stop being provided on the top plate, a cavity space being formed by the top plate and the bottom plate for holding connectors;
a connection rod having a top end section formed with an engaging slot which corresponds to a protruded section of the pivot seat to form a parallel structure, another end if the connection rod being connected to the seat body;
a bottom plate of the seat body and a placing surface being arranged in parallel, the seat body being connected to the connection rod forming a slot for holding the connection rod;
a first hinge chain positioned at the pivot seat and a top end of the connection rod so as to adjust an observation angle of the screen, the first hinge chain being positioned at the protruded section of the pivot seat and corresponding to the engaging slot to form a parallel structure containing the connection rod connected to the screen for adjustment of the observation angle;
a pivotal section mounted onto the seat body; and
a second hinge chain positioned at the pivot seat and another top end of the connection rod so as to adjust the height of the screen;
whereby the screen employs the pivot seat and the first hinge chain as a shaft center and the second hinge chain as a second shaft center, and the screen moves about a center point of the second shaft center and can be adjusted in position when the connection rod is rotated.
